(19) United States
(12) Patent Application Publication
(10) Pub. No.: US 2007/0076008 A1
(43) Pub. Date: Apr. 5, 2007

(54) Virtual local memory for a graphics processor

(76) Inventor: Randy B. Osborne, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/242,261

(22) Filed: Sep. 30, 2005

(51) Int. Cl. G06F 15/167

(52) U.S. Cl. 345/541

(57) ABSTRACT

A device, method, and system are disclosed. In one embodiment, the device comprises one or more graphics local memory channels, one or more system memory channels, and a graphics processor operable to access the one or more graphics local memory channels and the one or more system memory channels in an interleaving manner.

### FIELD OF THE INVENTION

The invention relates to virtual local memory for a graphics processor. More specifically, the invention relates to utilizing a physical address space for a graphics processor that includes address locations in both system memory and graphics local memory.

### BACKGROUND OF THE INVENTION

Many computing device applications that emphasize graphics and video have become complex and memory intensive for today's graphics processors. Additionally, many computing devices have been drastically reduced in size and price for mobility purposes as well as many other reasons. Even though the performance and price factors are seemingly at odds with each other, end users still expect high graphics performance at a modest price.

Moderately priced computing devices typically have a reduction in graphics performance from the high-end devices for a number of reasons. One reason is that the central processor in a device may share system memory with the graphics processor to conserve memory component costs. High-end graphics systems typically have their own separate graphics local memory that is smaller in storage size but usually has much higher bandwidth than system memory. Furthermore, graphics-intensive applications have been increasingly requiring not only high performance memory, but larger quantities of it too.

Thus, computer users today have a choice when it comes to graphical performance on computing devices, either pay the high-cost associated with graphics local memory or lose graphics performance by paying less for a system memory-only computing device.

### BRIEF DESCRIPTION OF THE DRAWINGS

The present invention is illustrated by way of example and is not limited by the figures of the accompanying drawings, in which like references indicate similar elements, and in which:

FIG. 1 is a block diagram of a computer system implementing one embodiment of virtual local memory for a graphics processor.

FIG. 2 is a block diagram of a computer system implementing another embodiment of virtual local memory for a graphics processor.

FIG. 3 is a block diagram of a computer system implementing yet another embodiment of virtual local memory for a graphics processor.

FIG. 4 is a block diagram of a computer system implementing still yet another embodiment of virtual local memory for a graphics processor.

FIG. 5 describes an embodiment of the memory usage of a computer system implementing virtual local memory for a graphics processor.

FIG. 6 is a flow diagram of one embodiment of a method for a graphics processor to access system memory and graphics local memory in a random, interleaving order.

FIG. 7 describes one embodiment of virtual graphics local memory apportioned with 50% graphics local memory and 50% system memory.

FIG. 8 describes one embodiment of virtual graphics local memory apportioned with 75% graphics local memory and 25% system memory.

FIG. 9 describes one embodiment of virtual graphics local memory apportioned with 67% graphics local memory and 33% system memory.

### DETAILED DESCRIPTION OF THE INVENTION

Embodiments of a virtual local memory for a graphics processor are disclosed. In the following description, numerous specific details are set forth. However, it is understood that embodiments may be practiced without these specific details. In other instances, well-known elements, specifications, and protocols have not been discussed in detail in order to avoid obscuring the present invention.

Implementing a virtual local memory for a graphics processor can effectively alleviate the problem requiring a user to choose between the high-cost of a computing device with graphics local memory or the low-performance of a computing device with only system memory. Embodiments of a virtual local memory allow the graphics processor the capability to utilize both graphics local memory and system memory simultaneously to create a good balance of graphics cost and performance. Virtual local memory synthesizes the equivalent bandwidth of a pure graphics local memory, e.g. of 2 channels, by using both a smaller amount of graphics memory, e.g. 1 channel, and system memory. In the simplest VLM option, half the required bandwidth comes from graphics local memory channel and half comes from system memory.

The concept behind virtual local memory is the same as a unified memory architecture (system+graphics memory), which is to share physical resources between processor and graphics to lessen cost, exploiting the fact that processor and graphics do not simultaneously need peak bandwidth all the time. However, virtual local memory has two important differences from the unified memory architecture.

First, virtual local memory adds some physical memory exclusively available for graphics in order to reduce the number of double data rate (DDR) channels required. One graphics double data rate (GDDR) channel is between 1.5× and 2× the speed of a DDR channel (for comparable technologies) and is easier to accommodate on a platform, and a lower cost, than 2 replacement channels of DDR memory. Second, although virtual local memory shares physical resources between processor and graphics, it does not share the address space. The processor and graphics have disjoint address spaces.

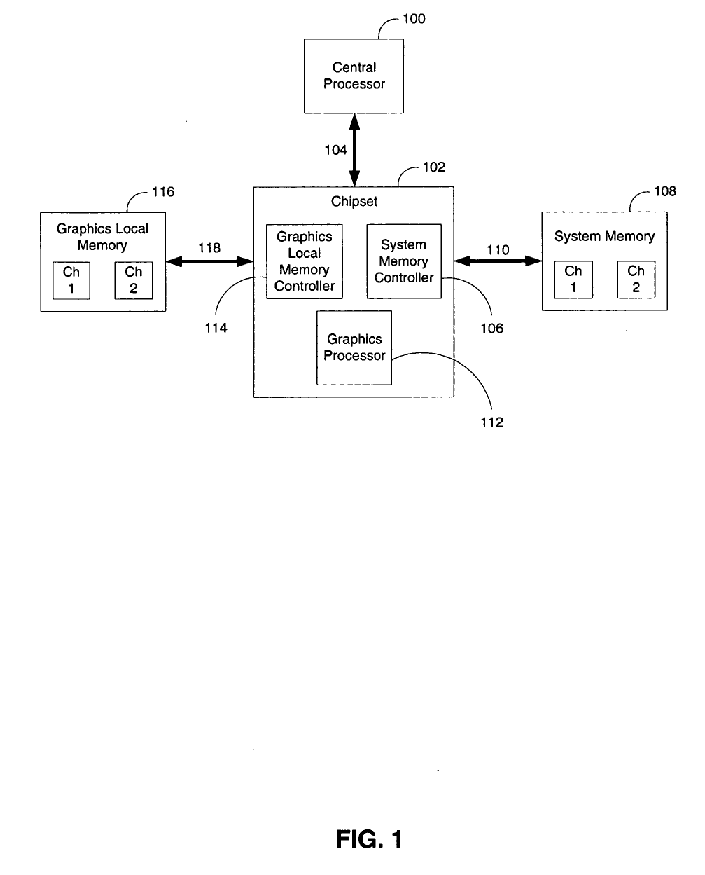

FIG. 1 is a block diagram of a computer system implementing one embodiment of virtual local memory for a graphics processor. In one embodiment, the computer system contains central processor 100 and chipset 102. Interconnect 104, coupled to both central processor 100 and chipset 102, is used for communication between these two agents. Interconnect 104 includes specific interconnect lines that send arbitration, address, data, and control information (not shown). In another embodiment, there are multiple central processors coupled to interconnect 104 (multiple processors are not shown in this figure).

System memory controller 106, integrated on chipset 102 in one embodiment, provides central processor 100 access to the system memory subsystem 108 through interconnect 110. In one embodiment, graphics processor 112 is integrated on chipset 102. Furthermore, in one embodiment, graphics local memory controller 114, also integrated on chipset 102, provides graphics processor 112 access to the graphics local memory subsystem 116 through interconnect 118.

In one embodiment, the computer system has two channels of system memory 108 (Ch 1 and Ch 2) and two channels of graphics local memory 116 (Ch 1 and Ch 2). In different embodiments, the system memory controller 106 may be coupled to one, two, three, four, or more channels of system memory and the graphics local memory controller 114 may be coupled to one, two, three, four, or more channels of graphics local memory. Interconnects 110 and 118 include specific interconnect lines that send arbitration, address, data, and control information (not shown). Information, instructions, and other data may be stored in system memory 108 channels 1 and 2 for use by central processor 100, graphics processor 112, as well as many other potential devices. Furthermore, information, instructions, and other data may be stored in graphics local memory 114 channels 1 and 2 for use by the graphics processor 1 0. In another embodiment, graphics local memory 114 does not exist, thus system memory 108 channels 1 and 2 are the only memory storage that graphics processor 112 can utilize. This configuration is not optimal for graphics memory performance because interconnect 110 is the only link between graphics processor 112 and system memory 108. Interconnect 110 and system memory 108 are shared with central processor 100 in this embodiment, thus graphics processor 112 does not have any dedicated memory channels nor does it have fast memory (system memory generally has lower bandwidth than graphics local memory for equal-width interfaces). Therefore, it is beneficial to have graphics processor 112 utilize one or more dedicated graphics local memory channels for performance purposes.

Thus, in one embodiment, the computer system has graphics local memory and graphics processor 112 utilizes only graphics local memory 116 for information storage. To supply the graphics processor with adequate memory bandwidth there may be a need for two or more graphics local memory channels so there is no performance limitation from memory. Graphics local memory generally has higher bandwidth for an equal width interface than system memory (as discussed above), thus it usually is more expensive per megabyte than an equal amount of system memory. Therefore, this solution is beneficial for graphics memory performance but it would generally cost more than the embodiment implementing only system memory.

Thus, in another embodiment, graphics processor 112 utilizes both system memory 108 and graphics local memory 116 to store information. In this embodiment, graphics processor 112 benefits from the speed of one or more graphics local memory channels supplemented by one or more system memory channels to lower the overall amount of graphics local memory channels necessary. Therefore, utilizing system memory bandwidth to supplement graphics local memory bandwidth allows the computer system to have less graphics local memory while keeping the same total graphics bandwidth requirement to maintain performance.

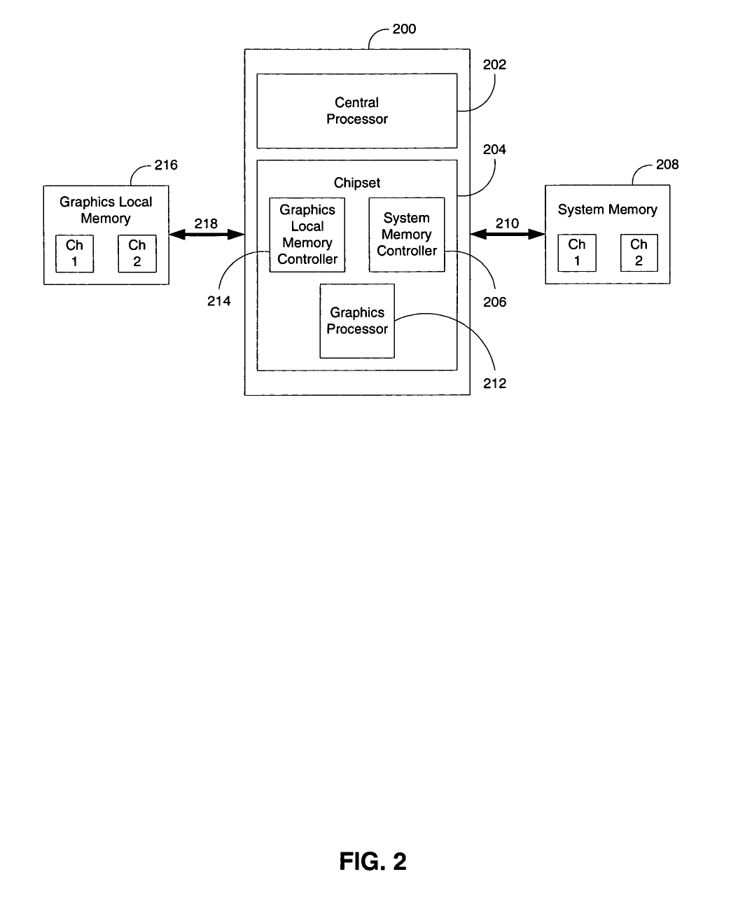

FIG. 2 is a block diagram of a computer system implementing another embodiment of virtual local memory for a graphics processor. The description of the computer system in FIG. 1 applies mostly in FIG. 2 as well. Furthermore, FIG. 2 describes a single chip system. In this embodiment, the central processor 202 and the chipset 204 reside on the same chip 200. Otherwise, the computer system in FIG. 2 functions similarly to the computer system described in detail in FIG. 1.

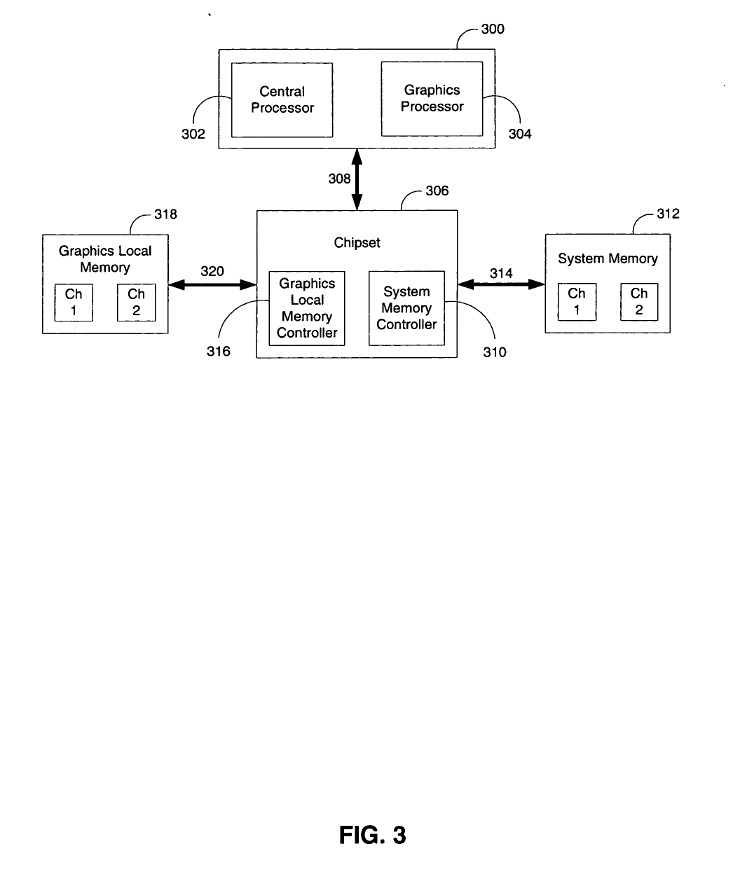

FIG. 3 is a block diagram of a computer system implementing yet another embodiment of virtual local memory for a graphics processor. The description of the computer system in FIG. 1 applies mostly in FIG. 3 as well. Furthermore, FIG. 3 describes a computer system that incorporates central processor 302 and graphics processor 304 on a single chip 300. Central processor 302 and graphics processor 304 communicate with chipset 306 through interconnect 308. The system memory controller 310 and the graphics local memory controller 316 are both located on chipset 306 to provide access to system memory through interconnect 314 and graphics local memory 318 through interconnect 320 respectively.

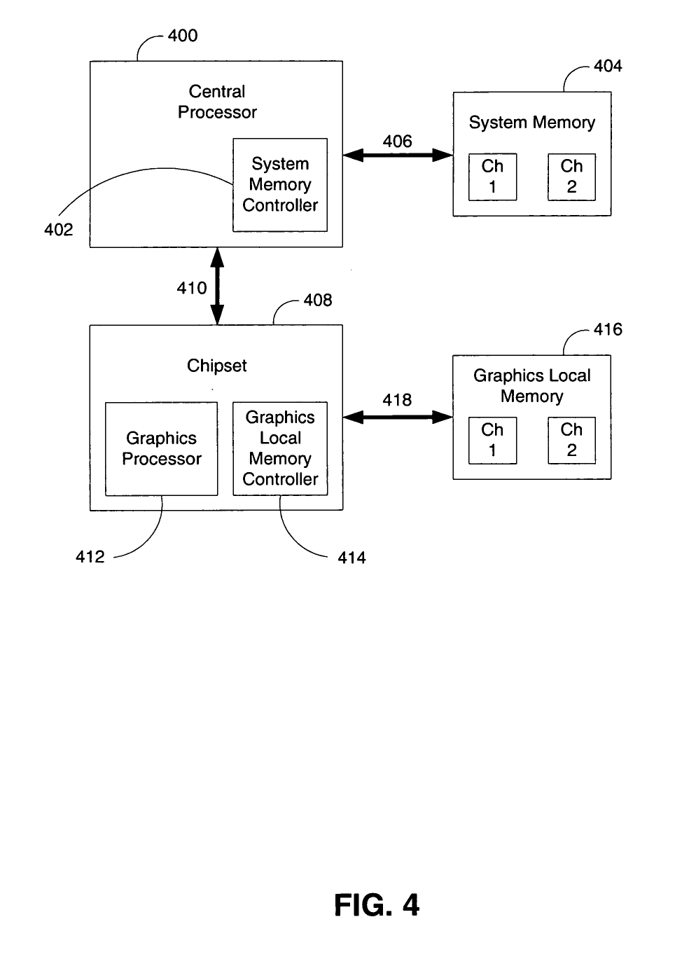

FIG. 4 is a block diagram of a computer system implementing still yet another embodiment of virtual local memory for a graphics processor. In one embodiment, the computer system contains central processor 400. In this embodiment, system memory controller 402 is integrated on the central processor 400 to provide access to system memory 404 through interconnect 406. In one embodiment, the computer system also contains chipset 408. Interconnect 410 provides a communication link between central processor 400 and chipset 408. In one embodiment, graphics processor 412 is integrated on chipset 408. In one embodiment, graphics local memory controller is also integrated on chipset 408 to provide access to graphics local memory 416 through interconnect 418. Interconnects 406, 410, and 418 are all used for communication between agents. These interconnects includes specific interconnect lines that send arbitration, address, data, and control information (not shown). Again, in another embodiment, there are multiple central processors located in the computer system and coupled to interconnects 406 and 410 (multiple processors are not shown in this figure).

In another embodiment, the graphics processor and graphics local memory controller are both located on the same integrated chip as the central processor (not shown). In this embodiment, graphics local memory has a direct interconnect to this integrated chip. In this embodiment, the system memory controller is located on the chipset and system memory has a direct interconnect to the chipset. Additionally, in this embodiment, the integrated chip (containing the central processor, graphics processor, and graphics local memory controller) communicates with the chipset (containing the system memory controller) across a common interconnect coupled to both devices.

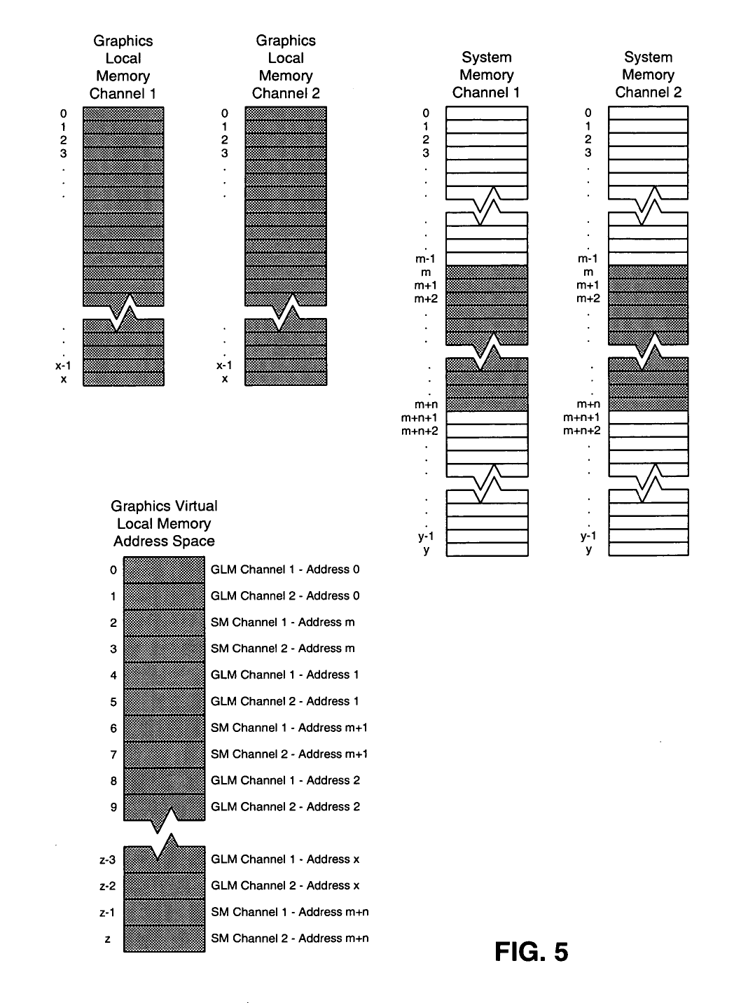

FIG. 5 describes an embodiment of the memory usage of a computer system implementing virtual local memory for a graphics processor. In this example embodiment, the graphics processor has sole use of both graphics local memory channel 1 and graphics local memory channel 2 (as shown with the cross-hatched locations 0 to x for both channels). Additionally, the graphics processor has sole use of a portion of system memory (as shown with the cross-hatched locations m to m+n for both channels). Thus, in this embodiment, starting at location m in each system memory channel a block of n system memory locations are reserved for use solely by the graphics processor. The graphics virtual local memory address space shows the virtual address locations that the graphics processor is aware of on the left (0-z in this example) and the physical address location on the right that corresponds to the actual locations in the graphics local memory channels and system memory channels. Thus, virtual address 0 corresponds to graphics local memory channel 1—address 0, virtual address 1 corresponds to graphics local memory channel 2—address 0, virtual address 3 corresponds to system memory channel 1—address m, and so on. In this case n=x. In this example, for a linear access stream, the graphics processor on average would access graphics local memory about 50% of all memory accesses and access system memory the remaining 50% of all memory accesses. The percentages are estimates based on the virtual memory space utilization implemented in this example embodiment. The access patterns to system memory and graphics local memory are averaged because there is no time-based sequential pattern to make them exact. The memory channel access percentages would be exact if all virtual memory locations were populated and there was a uniform access pattern that accessed all virtual memory locations the same number of times. In a real world application, a uniform access pattern is rarely the case, thus an average access percentage is estimated based on distribution of graphics local memory channel locations and system memory channel locations in the virtual address space. Thus, these average access percentages represent an interleaving pattern of accesses by the graphics processor to the one or more system memory channels and the one or more graphics local memory channels. An apportionment of bandwidth between the graphics local memory and system memory is the result. One skilled in the art will appreciate that the address interleaving can be generalized beyond the unit location granularity shown to include other granularities of interleaving, e.g. by blocks of 2 locations.

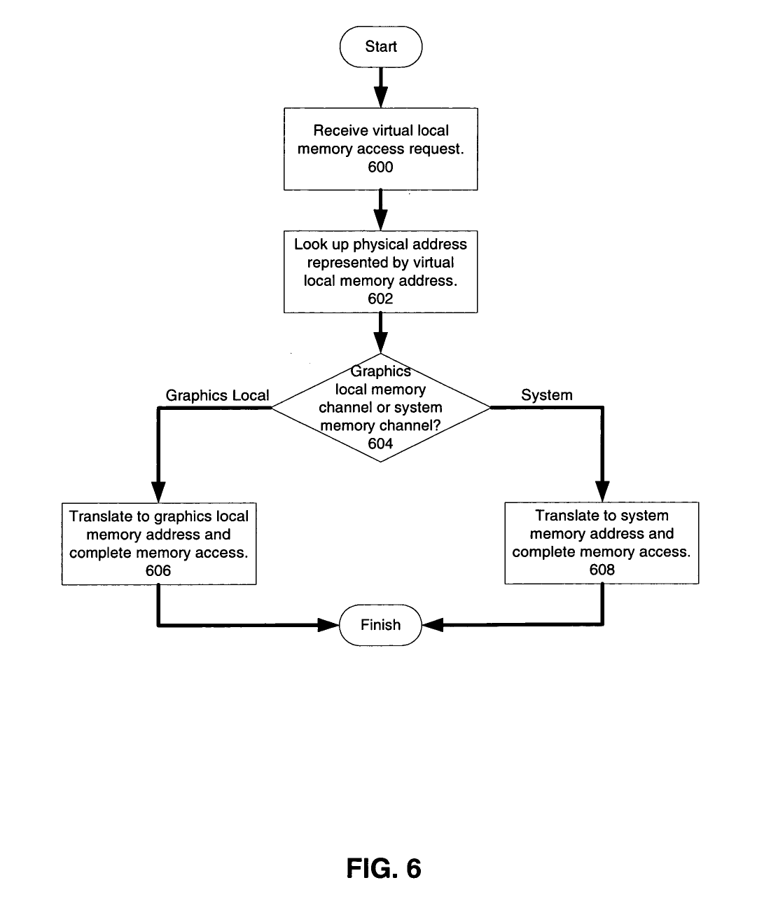

FIG. 6 is a flow diagram of one embodiment of a method for a graphics processor to access system memory and graphics local memory in a random, interleaving order. The method is performed by processing logic that may comprise hardware (circuitry, dedicated logic, etc.), software (such as is run on a general purpose computer system or a dedicated machine), or a combination of both. In one embodiment, the processing logic is located within a chipset that has an integrated graphics processor. Referring to FIG. 6, the method begins by processing logic receiving a memory access request to a location in graphics virtual local memory address space (processing block 600). Next, processing logic processes the access request by looking up the physical address represented by the virtual local memory address (processing block 602). The relationship between the physical address and the virtual local memory address is described above in reference to FIG. 5. Then processing logic obtains the lookup results and determines whether the requested access is to a system memory channel or a graphics local memory channel (processing block 604). If processing logic determines that the access is to a graphics local memory channel then processing logic translates the virtual address to the corresponding graphics local memory address and completes the memory access (processing block 606). Otherwise, if processing logic determines that the access is to a system memory channel then processing logic translates the virtual address to the corresponding graphics local memory address and completes the memory access (processing block 608) and the process is finished.

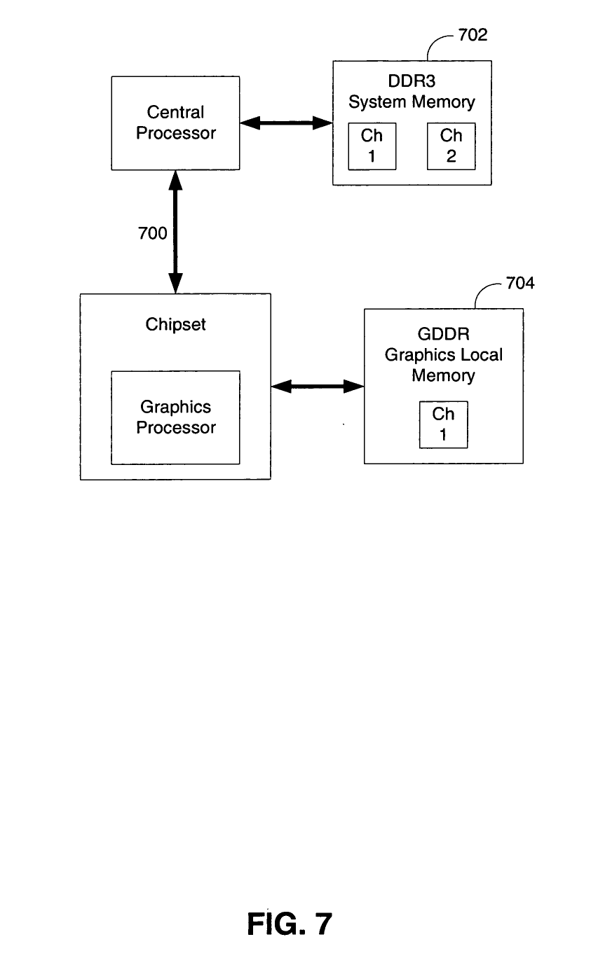

FIGS. 7 through 9 describe different example embodiments of possible apportionments of graphics local memory and system memory in virtual address space. The description of the computer system in FIG. 4 applies to the computer systems in FIGS. 7-9 as well. FIGS. 7-9 have all the memory controllers and functionality described in FIG. 4, but they are simplified for convenience.

FIG. 7 describes one embodiment of virtual graphics local memory apportioned with 50% graphics local memory and 50% system memory. In this embodiment, half of the graphics bandwidth comes from memory local to the graphics processor and half comes from system memory over interconnect 700. In one embodiment, system memory 702 is comprised of two channels of DDR3 (double data rate 3) memory and graphics local memory 704 is comprised of one channel of GDDR (graphics double data rate) memory. In one instantiation of this embodiment, the GDDR channel has double the bandwidth capacity of each channel of DDR3 memory for graphics processor to utilize (i.e., if GDDR is 1 unit of bandwidth, then each DDR3 is 0.5 units of bandwidth). Thus, in this instantiation, 50% of the graphics processor's memory bandwidth comes from the two DDR3 system memory channels and the other 50% comes from the one GDDR graphics local memory channel. This particular instantiation has two drawbacks: the peak bandwidth of each graphics memory channels must be twice that of each channel of system memory; and when graphics is using full bandwidth, there is no system bandwidth available for the CPU. The first drawback can be addressed by using any combination of system memory channel (e.g. DDR3) and graphics memory channel (e.g. GDDR) speeds. However, in this case either the system memory or the graphics memory may be under-utilized, depending on the ration of graphics to system memory bandwidths. The second drawback can be addressed by making the system memory channel peak bandwidth greater than half that of the graphics memory channel peak bandwidth. Thus when the graphics local memory is fully utilized there still will be bandwidth capacity available from the system memory channels to serve the CPU.

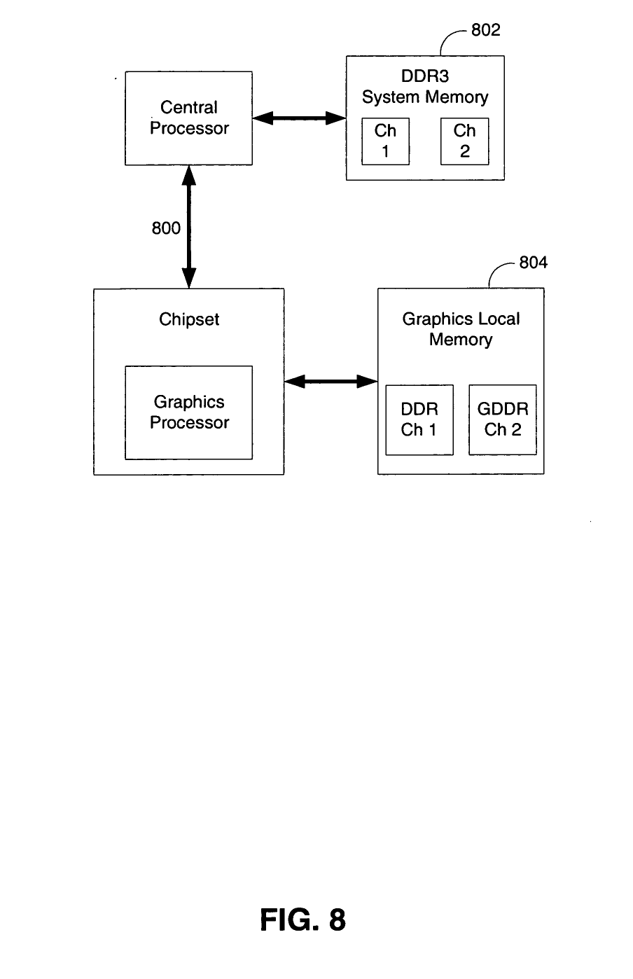

FIG. 8 describes one embodiment of virtual graphics local memory apportioned with 75% graphics local memory and 25% system memory. Thus, in this example embodiment, three quarters of the graphics bandwidth comes from memory local to the graphics processor and one quarter comes from system memory over interconnect 800. In this example embodiment, system memory 802 is comprised of two channels of DDR3 memory and graphics local memory 804 is comprised of one channel of DDR memory and one channel of GDDR memory. This embodiment adds more memory bandwidth local to the graphics processor in order to reduce the interference on the central processor.

In this example embodiment, the GDDR channel has double the bandwidth capacity of the graphics local memory DDR channel for graphics processor to utilize (i.e., if GDDR is 1 unit of bandwidth, then the graphics local memory DDR is 0.5 units of bandwidth). This local memory DDR can be cheaper than the GDDR, since it has less bandwidth, and at the same time cheaper than a system memory channel since less capacity is required than for system memory, and hence fewer memory devices are required. Furthermore, each DDR3 system memory channel supplies half the bandwidth of the graphics local memory DDR channel for the graphics processor to utilize (i.e., if graphics local memory DDR is 0.5 units of bandwidth, then each DDR3 system memory channel supplies 0.25 units of bandwidth). Thus, in this example embodiment, 25% of the graphics processor's memory bandwidth comes from the two DDR3 system memory channels and the other 75% comes from the GDDR graphics local memory channel and the DDR graphics local memory channel. In this example, since the DDR3 channels only supply 25% of the total graphics memory bandwidth, there is potentially more bandwidth available for CPU, since the DDR3 channel peak memory bandwidth is about half than of the GDDR channel peak memory bandwidth. Other variations are also possible where the DDR local graphics memory is slower, cheaper memory than the system memory, thereby reducing system cost.

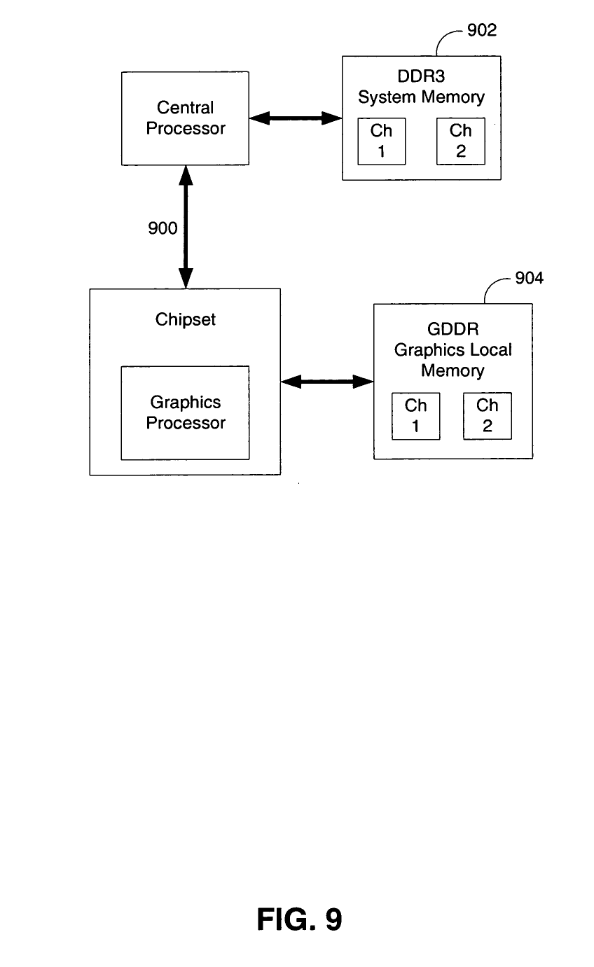

FIG. 9 describes one embodiment of virtual graphics local memory apportioned with 67% graphics local memory and 33% system memory. Thus, in this example embodiment, two thirds of the graphics bandwidth comes from memory local to the graphics processor and one third comes from system memory over interconnect 900. In this example embodiment, system memory 902 is comprised of two channels of DDR3 memory and graphics local memory 904 is comprised of two channels of GDDR memory. This embodiment again adds more memory bandwidth local to the graphics processor in order to improve graphics performance.

In this example embodiment, each GDDR graphics local memory channel has double the bandwidth capacity of each DDR3 system memory channel for graphics processor to utilize (i.e., if one GDDR channel is 1 unit of bandwidth, then each DDR3 channel is 0.5 units of bandwidth). Thus, in this example embodiment, 33% of the graphics processor's memory bandwidth comes from the two DDR3 system memory channels and the other 67% comes from the two GDDR graphics local memory channels. As in conjunction with FIG. 7, this embodiment can be generalized to have any ratio of GDDR to DDR3 channel bandwidths.

All options shown can be repeated for any of the topologies shown in FIGS. 1 through 4 and described in conjunction with those Figures.

Thus, embodiments of a virtual local memory for a graphics processor are disclosed. These embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A device, comprising:
one or more graphics local memory channels;
one or more system memory channels; and
a graphics processor operable to access the one or more graphics local memory channels and the one or more system memory channels in an interleaving manner.

2. The device of claim 1, further comprising a central processor operable to access the one or more system memory channels.

3. The device of claim 2, wherein the graphics processor and the central processor each have mutually exclusive system memory address spaces.

4. The device of claim 1, further comprising an interconnect coupled to the graphics processor and the central processor.

5. The device of claim 4, wherein the one or more graphics local memory channels and the one or more system memory channels are coupled to the graphics processor.

6. The device of claim 4, wherein the one or more graphics local memory channels and the one or more system memory channels are coupled to the central processor.

7. The device of claim 4, wherein the one or more graphics local memory channels are coupled to the graphics processor and the one or more system memory channels are coupled to the central processor.

8. The device of claim 1, further comprising a memory controller operable to provide access to the memory channels for the graphics processor.

9. The device of claim 1, wherein the graphics processor is physically located in a chipset.

10. The device of claim 1, further comprising two or more graphics local memory channels, wherein at least one channel comprises graphics double data rate memory and at least one channel comprises double data rate memory.

11. A method, comprising a graphics processor accessing one or more graphics local memory channels and one or more system memory channels in an interleaving pattern.

12. The method of claim 11, further comprising a central processor accessing the one or more system memory channels.

13. The method of claim 12, wherein the graphics processor and the central processor each have mutually exclusive system memory address spaces.

14. A system, comprising:
a first bus;
a system memory coupled to the bus;
a second bus;
a graphics local memory coupled to the second bus;
a graphics processor coupled to the first bus and second bus; and
a memory controller operable to provide memory access to the graphics processor by accessing the graphics local memory and the system memory in an interleaving manner.

15. The system of claim 14, further comprising a central processor operable to access the one or more system memory channels.

16. The system of claim 15, wherein the graphics processor and the central processor each have mutually exclusive system memory address spaces.

17. The system of claim 14, wherein the system memory and the graphics local memory are each further comprised of one or more memory channels.
